(19) United States
(12) Patent Application Publication
(10) Pub. No.: US 2012/0280941 A1
(43) Pub. Date: Nov. 8, 2012

(54) Projection display system for table computers

(75) Inventor: Darwin HU, Wuhan (CN)

(73) Assignee: WUHAN SPLENDID OPTRONICS TECHNOLOGY CO., LTD

(21) Appl. No.: 13/535,361

(22) Filed: Jun. 28, 2012

Related U.S. Application Data
(63) Continuation of application No. PCT/CN2010/074356, filed on Jun. 23, 2010.

(30) Foreign Application Priority Data
Dec. 28, 2009 (CN) 200910251608.0

(51) Int. Cl. G06F 3/042

(52) U.S. Cl. 345/175

(57) ABSTRACT

The invention pertains to a multiple-touch detection device for projection displays. According to one aspect of the present invention, an image sensor is disposed in a light engine of a projection system. The sensor detects signals from respective touches on a display screen and transmits the signals to an image processing module to determine respective coordinates of the touches.

### CROSS REFERENCE TO RELATED APPLICATIONS

This application is a continuation of International Application No. PCT/CN2010/074356 filed on Jun. 23, 2010, which claims the priority of Chinese Patent Application No.: 200910251608.0 filed on Dec. 28, 2009.

### BACKGROUND OF THE INVENTION

1. Field of the Invention

The present invention is related to the area of projection display technologies, particularly to a projection display system for a table computer to detect one or more touch points thereon.

2. Description of Related Art

A projection display is a system that receives image signals from an external electronic video device and projects an enlarged image onto a display screen. A projection display system is commonly used in presenting visual information to a large audience. Generally, a projection display system contains a light source, a light engine, a controller and a display screen. When an image is fed into a projection display system, a video controller takes pixel information of the image, for example, color and gray level, and controls operations of imaging elements in the light engine accordingly to reproduce or reconstruct the image. Depending on the image elements used in the light engine, a complete color image is reconstructed from either combining or modulating three primary color images before being projected to the display screen.

There are three main types of projection display systems. The first one is called as liquid-crystal-display projection display system (LCD), which is made up of pixels filled with liquid crystals between two transparent panes. The liquid crystal acts like an optical valve or gate. The amount of light allowed to transmit through each pixel is determined by a polarization voltage applied to the liquid crystal in the pixel. By modulating this polarization voltage, the brightness, or gray level, of the image can be controlled. For color images, three primary color lights separated from a white light source are respectively directed to pass through three LCD panels. Each LCD panel displays one of the primary colors (e.g., red, green, or blue) of the image based on the pixel information received by the controller. These three primary color images are then combined in the light engine to reproduce a complete color image. Through a projection lens, the reconstructed image is collimated, enlarged and projected directly or indirectly onto a display.

A second type of projection system is known as digital light processing projection display system (called DLP projection display system for short). A core component of the DLP projection display system is a digital micro-mirror device containing tiny mirror arrays. Each mirror in the tiny mirror arrays represents or corresponds to one pixel of an image. The light, instead of passing through a controlled valve or gate as in an LCD system, is reflected from a mirror pixel. The amount of light that reaches the projection lens from each pixel is controlled by moving the mirrors back and forth and directing the light into or away from the projection lens. Image color is obtained by passing the source light through a rotating wheel with red, green, and blue filters. Each primary color, as they exit from the filter, is reflected by the mirrors in a rapid rotating sequence. When projected, a color-modulated image, which the human eyes perceive as natural color, is reproduced.

A third type of projection is called as Liquid-Crystal-on-Silicon (LCOS) projection display system. Instead of passing light through liquid crystals between two transparent panels like an LCD, or reflecting light using tiny mirror arrays like a DLP, an LCOS projection system has a liquid crystal layer between a transparent thin-film transistor (TFT) layer and a silicon semiconductor layer. The silicon semiconductor layer has a reflective and pixilated surface. As an incident light is prjected onto the LCOS micro-device, the liquid crystals act like optical gates or valves, controlling the amount of light that reaches the reflective silicon semiconductor surface beneath. The LCOS is sometimes viewed as a combination of an LCD and a DLP.

The color rendering in a LCOS system is similar to that of a LCD display. A white light source is separated into the three primary color lights by passing through a series of wavelength selecting dichroic mirrors or filters. The separated primary color lights go through a set of polarized beam splitters (PBS), which redirects each primary color light to individual LCOS micro-device responsible for a primary color of the image. Specifically, the blue light is directed to the LCOS micro-device responsible for blue color, the red light is directed to the LCOS micro-device responsible for red color, and the green light is directed to the LCOS micro-device responsible for green color. The LCOS micro-device modulates the polarization of the liquid crystal for each pixel corresponding to the gray scale level defined for each pixel by the image content, and reflects back an image of a primary color. The three separate primary color images are then reassembled as they pass through the PBS set. A complete color image is reconstructed and beamed to a projection lens to display it on a screen.

The use of these large projection displays has received considerable attention recently, especially in the field of table computers, or surface computing. Instead of a keyboard and mouse, surface computing uses a specialized user interface which allows a user to interact directly with a touch-sensitive screen to manipulate objects being shown on the screen. One key component in the surface computing is the capability of detecting multiple-touch contacts when a user interacts with the objects being shown on the display.

FIG. 11 shows a configuration of a multiple-touch detection system in a table computer 1100. In this configuration, a video image is projected onto a display surface 1110 from a projection lens 1120 in a projection display system. The projection lens 1120 is located at the center of the back panel facing the display surface 1110. A near-infrared LED light source 1140 projects 850-nanometer-wavelength light to the back of the display surface 1110. When an object touches the display surface 1110, the near-infrared light reflects from the display surface 1110 at the location where touches take place. Four infrared cameras 1130, each covers an area approximately a quarter of the display surface 1110, detect the near-infrared lights reflected from the display surface 1110. A processor (not shown) combines the images from each of the cameras 1130 and calculates the location of the touch inputs accordingly.

A table computer, such as the Microsoft Surface, which directly projects an image to a display surface, usually places the projection lens at a place corresponding to the center of the display screen to avoid distortions of the projected image. Any camera installed to detect touch inputs has to be placed off the center of the projection lens. If only one off-centered camera is used to cover the entire display area for touch input detection, the infrared image captured will be distorted. Determining accurate touch locations from analyzing such distorted image in the subsequent calculations would be complicated and difficult. Therefore, for projection display systems like Microsoft Surface as shown in FIG. 11, multiple cameras are required. Each camera covers only a portion of the display. The undistorted image from each camera is then combined to create an image covering the whole display surface. For display systems projecting images indirectly to the display surface, the optical elements, such as mirrors and lenses used to redirect the projected image, may also prevent the use of a single camera at the center location for multiple touch input detections.

To precisely detect multiple-touch inputs for a projection display system, the prior art technique requires an infrared light source, multiple infrared cameras and resources to combine the images from each individual camera. These requirements drive up the cost of the table computer systems and increase the complexity of surface computing.

There is thus a need for a more compact and inexpensive multiple-touch detection device for the projection display systems.

### SUMMARY OF THE INVENTION

This section is for the purpose of summarizing some aspects of the present invention and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present invention.

The invention pertains to a multiple-touch detection device for projection displays. Different from the prior art touch sensitive displays which require special hardware built into the system, the present invention can be installed to existing LCOS or LCD projection display systems without significantly altering the designs of the systems. According to one aspect of the present invention, an image sensor is disposed to at least one of the surfaces of an optical assembly (or engine) in a projection system. The image sensor detects signals from respective touches on a display screen using the same optical assembly. The signals are coupled to an image processing module that is configured to determine coordinates of the touches.

As an object (e.g., a finger or hand or an infrared-based stylus) touches the projection display screen, the temperature at the touched locations on the display increases or changes. As a consequence of the temperature change, infrared (IR) and near-infrared (near-IR) waves are emitted from the location where the touch takes place. Utilizing the optical elements in a light engine of a projection display system, an IR or near-IR sensitive device (sensor) is provided on at least one of the surfaces of the light engine, where the IR emission from the touch point can be detected. The IR or near-IR sensor is connected to an image-processing module, where an image containing the detected IR signals are converted into digital images, enhanced and processed. As a result, the locations or coordinates of the detected IR signals are determined. The image-processing module outputs the detected result for subsequent processes, e.g., detecting movements of the touch inputs.

The present invention may be implemented as an apparatus, a method or a system. According to one embodiment, the present invention is a projection system comprising a display screen, an optical assembly to project an image onto the display screen, and a sensor provided to sense at least a touch on the display screen using the optical assembly as a focus mechanism. The optical assembly includes a group of prisms to combine three primary color images respectively generated by three sources coupled to an image source. Depending on implementation, the three sources are imaging units that include, but not limited to, Liquid crystal on silicon (LCOS) imagers or Liquid crystal display (LCD) imagers.

According to another embodiment, the present invention is a projection system comprising: a table structure, a display screen being a surface of the table structure, an optical assembly provided behind the display screen, an image sensor provided to sense at least a touch on the display screen using the optical assembly to focus the touch back onto the image sensor while the optical assembly simultaneously projects a full color image onto the display screen, and an image processing module coupled to the image sensor to receive a captured image therefrom to determine coordinates of the touch on the display screen.

The foregoing and other objects, features and advantages of the invention will become more apparent from the following detailed description of a preferred embodiment, which proceeds with reference to the accompanying drawings.

### BRIEF DESCRIPTION OF THE DRAWINGS

These and other features, aspects, and advantages of the present invention will become better understood with regard to the following description, appended claims, and accompanying drawings where:

FIG. 1 shows one embodiment of a typical LCD projection display system;

FIG. 2 shows one embodiment of a LCD projection display system with touch detection;

FIG. 3 shows one part of another embodiment of a LCD projection display system with touch detection;

FIG. 4 shows one embodiment of a LCOS projection display system;

FIG. 5 shows one embodiment of a LCOS projection display system with touch detection;

FIG. 6 shows another embodiment of a LCOS projection display system;

FIG. 7 shows another embodiment of a LCOS projection display system with touch detection;

FIG. 8 shows an exemplary embodiment of an image processing module that may be used in FIG. 2, 3, 5 or 7;

FIG. 9 shows one embodiment of an IR stylus used in conjunction with an IR sensitive device; and

FIG. 10 shows one embodiment of a table computer using a projection display system shown in FIGS. 2, 3, 5 and 7;

FIG. 11 shows a configuration of a projection display system in a convention table computer.

### DETAILED DESCRIPTION OF THE INVENTION

The detailed description of the present invention is presented largely in terms of procedures, steps, logic blocks, processing, or other symbolic representations that directly or indirectly resemble the operations of devices or systems contemplated in the present invention. These descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams or the use of sequence numbers representing one or more embodiments of the invention do not inherently indicate any particular order nor imply any limitations in the invention.

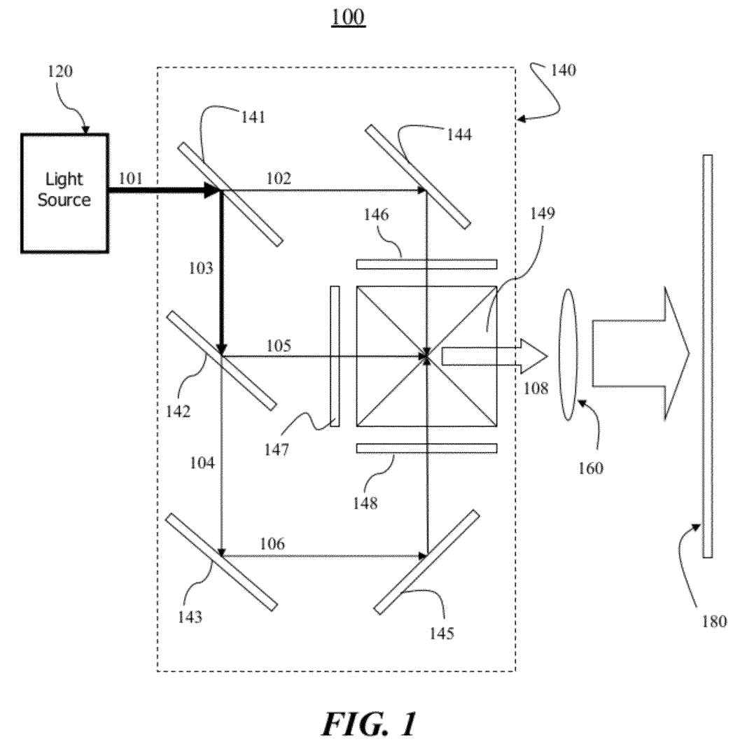

FIG. 1 shows schematically an exemplary LCD projection display system 100 according to one embodiment of the present invention. The projection display system 100 includes a light source 120, an optical engine 140, a projection lens 160, and a display screen 180. The light source 120 produces and directs a white light 101 to the optical engine 140. The optical engine 140 includes a guidance mirror assembly, three LCD panels 146, 147, and 148, and an optical prism assembly 149. Each of the LCD panels 146, 147, and 148 is respectively responsible for one of three primary colors of the image projected onto the display screen 180. The guidance mirror assembly is provided to separate the white light 101 into the three primary color lights (e.g., a red light, a green, and a blue light), and direct the primary color lights to corresponding LCD panels. A video controller (not shown) drives the three LCD panels 146, 147, and 148 to produce respectively three primary color images (being an image in optics herein, referred to as optical image herein), based on an input image (being an image in data as provided herein, referred to as a digital image herein). The optical prism assembly 149 combines the three primary color images to a full color image 108 and transmits the full color image 108 to the projection lens 160. The projection lens 160 directly or indirectly projects the full color image 108 onto the display screen 180.

As shown in FIG. 1, the LCD panel 146 is responsible for green color of the image projected on the display screen 180. The LCD panel 147 is responsible for blue color of the image projected on the display screen 180. The LCD panel 148 is responsible for red color of the image projected on the display screen 180. The guidance mirror assembly includes three types of dichroic mirrors 141, 142, and 143, and two reflection mirrors 144 and 145. The dichroic mirror 141 selectively transmits a green light 102 and reflects the remaining (magenta) light 103 composing a red light and a blue light. The green light 102 transmitted through the dichroic mirror 141 is then reflected by the reflection mirror 144 to the LCD panel 146. At the same time, the dichroic mirror 142 intercepts the magenta light 103, selectively transmits the red light 104 and other higher wavelength lights (e.g. IR), and reflects the blue light 105 to the LCD panel 147. Furthermore, the dichroic mirror 143 separates and reflects the red light 106 to the reflection mirror 145. The reflection mirror 145 then reflects the red light 106 to the LCD panel 148. The video controller controls the LCD panel 146 to produce a green image, controls the LCD panel 147 to produce a blue image, and controls the LCD panel 148 to produce a red image based on the input image. The optical prism assembly 149 combines the three primary color images to a full color image 108 and projects the full color image 108 on the projection lens 160.

In other embodiments, the optical characteristics of the three dichroic mirrors can be adjusted according to any special requirements, only if three primary color lights can be produced through them. For example, the dichroic mirror 141 is designated to transmit the blue light, the dichroic mirror 142 is designated to reflect the red light, and the dichroic mirror 143 is designated to reflect the blue light. With the change of the optical characteristics of the dichroic mirrors, the primary color of the image which the LCD panels 146, 147, and 148 are responsible for may change accordingly.

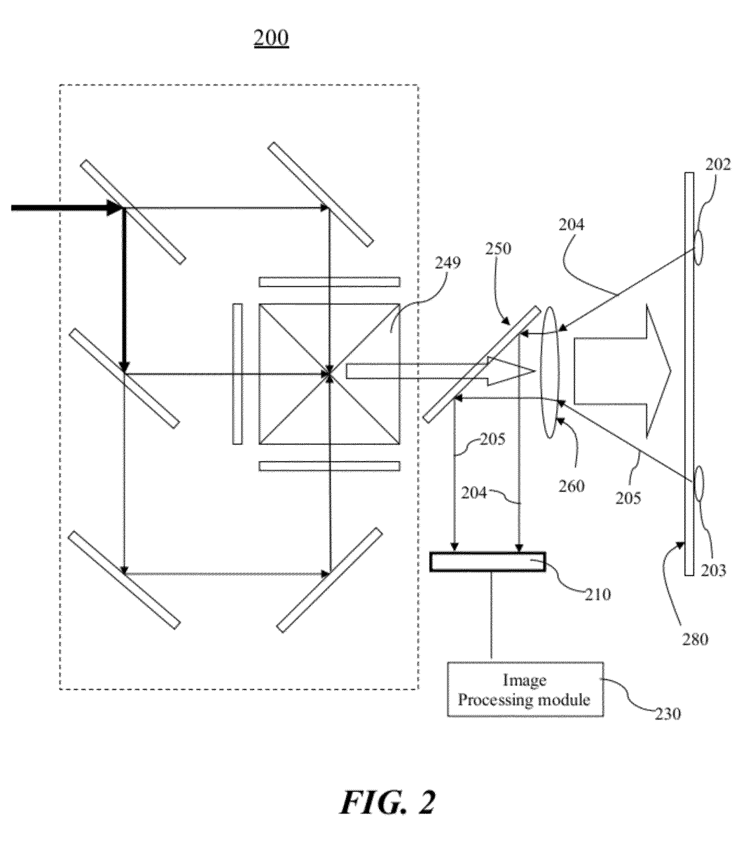

FIG. 2 shows a configuration of a LCD projection display system 200 used in for touch detection according to one embodiment of the present invention. The LCD projection display system 200 shown in FIG. 2 is identical in structure to the LCD projection display system 100 shown in FIG. 1 except that the projection display system 200 further comprises an image sensor 210, an image processing module 230, and a reflection mirror 250. The same structures between the projection display systems 100 and 200 work in a substantially similar manner.

The reflection mirror 250 is disposed between the projection lens 260 and the optical prism assembly 249 to reflect an infrared light from the projection lens 260 to the image sensor 210 without influence on the images projected from the optical prism assembly 249. The image sensor 210 may be a charge-coupled device (CCD) sensor or a complementary metal oxide semi-conductor (CMOS) sensor, and provided to capture the infrared light reflected by the reflection mirror 250 to produce an infrared image and transmit the infrared image to the image processing module 230. The image sensor 210, the infrared reflection mirror 250, the projection lens 260, and the image processing module 230 cooperate with each other to detect one or more touch on the display screen 280.

FIG. 2 shows a touch detection example in one embodiment of the present invention. When an object 202 (e.g., a finger, a stylus, or other objects) touches on the display screen 280, an IR light 204 is generated from a touch of the object 202. The IR light 204 follows a projection light path and travels through the projection lens 260 to the reflection mirror 250. The reflection mirror 250 reflects the IR light 204 to the image sensor 210. Similarly, when an object 203 touches on the display screen 280, an IR light 205 may be generated from a touch of the object 203. The IR light 205 follows the projection light path and travels through the projection lens 260 to the reflection mirror 250. The reflection mirror 250 reflects the IR light 205 to the image sensor 210. Pixels in the image sensor 210 correspond to positions on the display screen 280. Therefore, coordinates of the touches of the objects 202 and 203 on the display screen 280 can be calculated by analyzing sensing points of the infrared image outputted from the image sensor 210.

In summary, when multiple touches occur, each touch may generate an IR signal, which travels to the projection lens along the projection light path, and is finally captured by the image sensor 210. Then, the image processing module 230 calculates coordinates of each touch. The image processing module 230 is provided to process and analyze the infrared image from the image sensor 210 to obtain the coordinates of the touches. The operation of the image processing module will be more detailed below.

In one embodiment, the reflection mirror 250 is an infrared reflection mirror, which only reflects the infrared light from the projection lens 260 but has no effect on the visible light from the projection lens 260. Therefore, the infrared light from the projection lens 260 can easily reach the image sensor 210, where the image sensor 210 is configured to generate the infrared image with one or more infrared sensing points. However, the visible light and the ultraviolet light cannot reach the image sensor 210 due to the block of the infrared reflection mirror 205, thereby eliminating or decreasing interference of the visible light and the ultraviolet light to the image sensor 210.

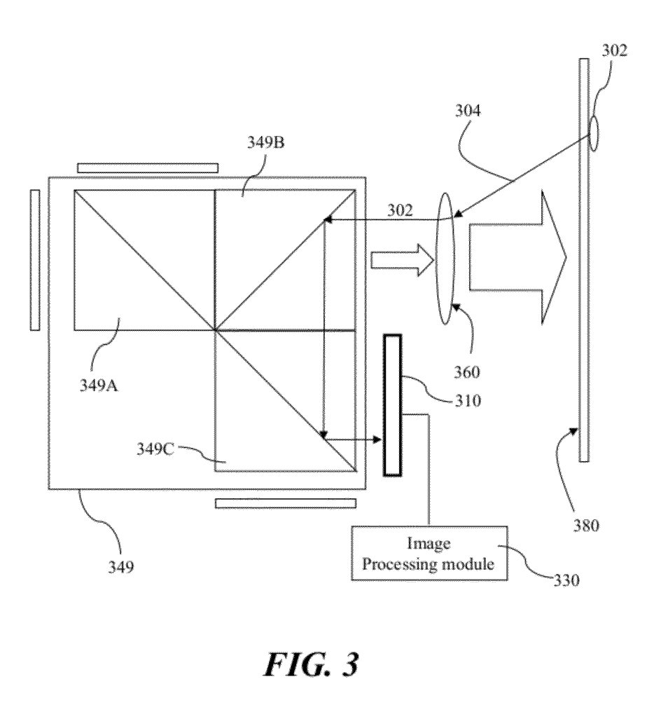

FIG. 3 shows a configuration of an LCD projection display system 300 with touch detection according to another embodiment of the present invention. The LCD projection display system 300 shown in FIG. 3 is similar to the LCD projection display system 200 shown in FIG. 2 in structure. The differences between the projection display systems 200 and 300 comprise at least the follow: i), the optical prism assembly 349 of the projection display system 300 is different from that 249 of the projection display system 200, and ii) the projection display system 300 does not have the reflection mirror corresponding to that 250 of the projection display system 200. Nevertheless, the projection display systems 200 and 300 work in a similar manner. The optical prism assembly 349 comprises three individual optical prisms 349A, 349B and 349C. The optical prism assembly 349 can also combine the three primary color images from the LCD panels to the full color image that may be projected onto the display screen 380 by the projection lens 360. The infrared reflection mirror as shown in FIG. 2 is not required in this embodiment, and the optical prism assembly 349 is configured to reflect the infrared light from a projection lens 360 to an image sensor 310. The image sensor 310 is provided to generate an infrared image and transmit the infrared image to an image processing module 330. FIG. 3 shows a touch detection example according to one embodiment of the present invention. When an object 302 (e.g., a finger, a stylus, or other objects) touches the display screen 380, an IR light 304 may be generated from a touch of the object 302. The IR light 304 follows the projection light path and travels through the projection lens 360 to the optical prisms 349B. The optical prisms 349B reflects the IR light 304 to the optical prisms 349C, and the optical prisms 349C reflects the IR light 304 to the image sensor 310.

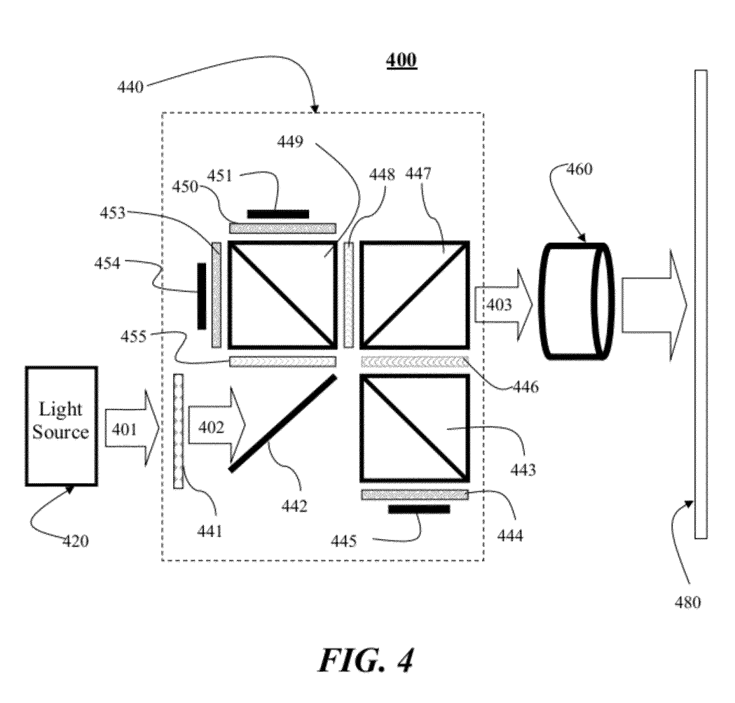

FIG. 4 shows an LCOS projection display system 400 that may be equipped with one embodiment of the present invention. The projection display system 400 comprises a light source 420, an optical engine 440, a projection lens 460 and a display screen 480. The light source 420 produces and directs a white light 401 to the optical engine 440. The white light 401 becomes an S-polarized white light 402 after passing though a wire-grid polarizer 441. A dichroic mirror 442 is provided to separate the white light 402 to allow a green light to pass through and reflect the remaining (magenta) light including a red light and a blue light. The green light travels to a polarizing beam splitter (PBS) 443 and is reflected onto an LCOS micro-device 445 responsible for a green color of a projected image. A quarter-wave plate 444 situated before the LCOS micro-device 445 enhances the entering green light. The LCOS micro-device 445 modulates the incident green light to generate a P-polarized green image based on pixel information of an input data image from a video controller (not shown), and reflects a P-polarized green image. The reflected green image passes through the PBS 443 and a wave plate 446 that converts the green light back to S-polarization, then enters a PBS 447.

The reflected magenta light from the dichroic mirror 442 enters a PBS 449 through a narrow-band half-wave retarder 455. The narrow-band half-wave retarder 455 switches the polarization only in the red waveband portion of the magenta light, thereby converting only the red waveband portion from S-polarization to P-polarization. The P-polarized red light passing through the PBS 449 and a quarter-wave plate 450 arrives at an LCOS micro-device 451 responsible for a red color of the projected image. The S-polarized blue light reflected by the PBS 350 passing through a quarter-wave plate 453 and arrives at an LOCS micro-device 454 responsible for a blue color of the projected image. As the red and blue color images reflected by their respective LCOS micro-device 451 and 454, their polarization changes. The reflected red color image becomes S-polarized and is reflected at the PBS 449 while the reflected blue color image becomes P-polarized and is transmitted through the PBS 449. Another narrow-band half-wave retarder 448 is placed next to the PBS 449 to switch the red image from S-polarization to P-polarization without affecting the polarization of the blue image. The P-polarized red and blue images then transmit through a PBS 447, and are combined with the S-polarized green image passing through the PBS 443 and the wave plate 446 to produce a complete color image 403. The complete color image 403 enters a projection lens 460 and is projected directly or indirectly onto a display screen 480.

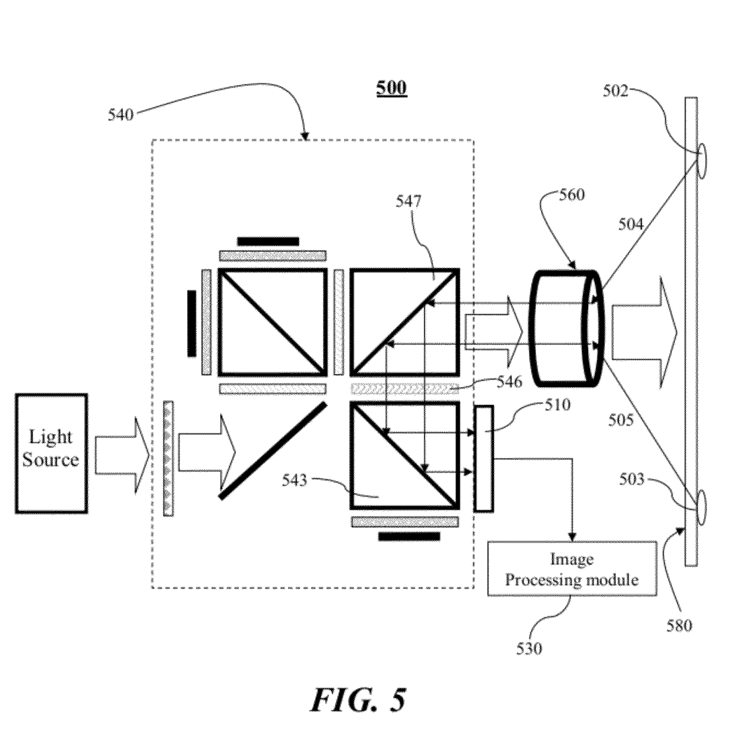

FIG. 5 shows a configuration of an LCOS projection display system 500 with touch detection according to one embodiment of the present invention. The LCOS projection display system 500 shown in FIG. 5 is similar to the LCOS projection display system 400 shown in FIG. 4 in structure except that the projection display system 500 further comprises an image sensor 510 and an image processing module 530. The same structures between the projection display systems 400 and 500 work in similar manner. The image sensor 510 may be a charge-coupled device (CCD) sensor or a complementary metal oxide semi-conductor (CMOS) sensor, and be provided to capture an infrared light from a projection lens 560 to produce an infrared image and transmit the infrared image to the image processing module 530. The image sensor 510, the projection lens 560, and the image processing module 530 cooperate with each other to detect one or more touch on a display screen 580.

FIG. 5 shows a touch detection example in one embodiment of the present invention. When an object (e.g., a finger or hand, or an IR-based stylus) 502 touches on the display screen 580, an infrared signal 504 may be generated from a touch of the display screen 580. The infrared signal 504 follows a projection light path and travels through the projection lens 560 to an optical engine 540. A PBS 547 and a PBS 543 in the optical engine 540 reflect an S-polarized component of the IR signal 504 to the image sensor 510. Similarly, when an object 503 touches on the display screen 580, an IR light 505 may be generated from a touch of the object 503. The infrared signal 505 follows the projection light path and travels through the projection lens 560 to the optical engine 540. The PBS 547 and the PBS 543 in the optical engine 540 reflect an S-polarized component of the IR signal 505 to the image sensor 510. Pixels in the image sensor 510 correspond to positions on the display screen 580. Therefore, coordinates of the touches of the objects 502 and 503 on the display screen 580 can be calculated by analyzing sensing points of the infrared image outputted from the image sensor 510. In summary, when multiple touches occur, each touch may generate an IR signal that follows the projection light path, travels to the projection lens, and is finally captured by the image sensor 510. Then, the image processing module 530 is configured to calculate the coordinates of each touch. The image processing module 530 is provided to process and analyze the infrared image from the image sensor 510 to obtain the coordinates of the touches. The operation of the image processing module 530 will be more detailed below.

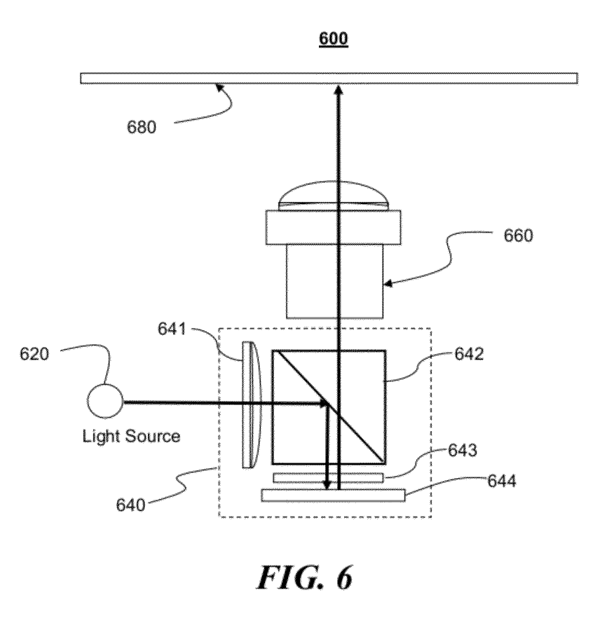

FIG. 6 shows schematically a LCOS projection display system 600 according to another embodiment of the present invention. The projection display system 600 comprises a light source 620, an optical engine 640, a projection lens 660 and a display screen 680. The light source 620 includes a red LED (light-emitting diode), a green LED and a blue LED. Red, green and blue lights are emitted in a rapid rotating sequence from the light source 620, and each time a single-colored light is emitted from the light source 620. The light emitted by the light source 620 enters the light engine 640, then passes through an element 641 including an S-polarizing filter and a collimating lens, and subsequently enters a polarizing beam splitter prism (PBS) 642. The S-polarized light is reflected in the PBS 642 and directed through a quarter-wave plate 643 to a LCOS device 644. Based on pixel information of the input data image to be displayed, the LCOS device 644 produces a monochrome image containing only the incident color light component (e.g., the red-component of an image). As the S-polarized light is reflected from the LCOS device 644, the polarization changes to P-polarization. The P-polarized light, or image, then reenters and passes through the PBS 642. The projection lens 660 projects the monochrome image from the PBS 642 onto the display screen 680. As the three primary colors, RGB, are emitted from the light source 620 in a rapid repeating sequential order, their respective monochrome images are produced and projected on the display screen 680 in the same rapid sequence. Consequently, a color-modulated image, which the human eyes perceive as natural color, is reproduced.

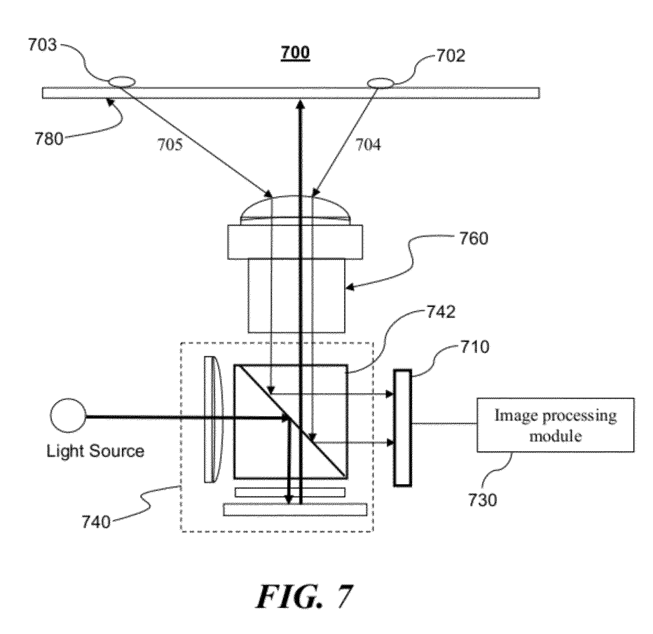

FIG. 7 shows a configuration of a LCOS projection display system 700 with touch detection according to another embodiment of the present invention. The LCOS projection display system 700 shown in FIG. 7 is similar to the LCOS projection display system 600 shown in FIG. 6 in structure except that the projection display system 700 further comprises an image sensor 710 and an image processing module 730. The similar structures between the projection display systems 600 and 600 work in similar manner. The image sensor 710 may be a charge-coupled device (CCD) sensor or a complementary metal oxide semi-conductor (CMOS) sensor, and be provided to capture an infrared light from a projection lens 760 to produce an infrared image and transmit the infrared image to the image processing module 730. The image sensor 710, the projection lens 760, and the image processing module 730 cooperate with each other to detect one or more touch on a display screen 780.

FIG. 7 shows a touch detection example in one embodiment of the present invention. When an object (e.g., a user's finger or hand, or an IR-based stylus) 702 touches on the display screen 780, an infrared signal 704 may be generated from a touch of the display screen 780. The infrared signal 704 follows a projection light path and travels through the projection lens 760 to an optical engine 740. A PBS 742 in the optical engine 740 reflects an S-polarized component of the IR signal 704 to the image sensor 710. Similarly, when an object 703 touches on the display screen 780, an IR light 705 may be generated from a touch of the object 703. The infrared signal 705 follows the projection light path and travels through the projection lens 760 to the optical engine 740. The PBS 742 in the optical engine 740 reflects an S-polarized component of the IR signal 705 to the image sensor 710. Pixels in the image sensor 710 correspond to positions on the display screen 780. Therefore, coordinates of the touches of the objects 702 and 703 on the display screen 780 can be calculated by analyzing sensing points of the infrared image outputted from the image sensor 710. Likewise, the operation of the image processing module 730 may be described in detail below.

In one embodiment, the projection lens 260, 360, 560 or 760 is configured to block a visible light and an ultraviolet light from the display screen, and allow an infrared light from the display screen to pass through, thereby eliminating or decreasing interference of the visible light and the ultraviolet light to the image sensor 210, 310, 510 or 710. The optical engine and the projection lens are referred as to optical assembly in the present invention. One of the advantages, benefits and objectives in the present invention is that the projection lens is used as an image capturing lens of the image sensor to capture the infrared image from the display screen or the direction of the display screen, and then the infrared image from the projection lens is directed to the image sensor by the optical elements in the optical engine or other optical elements.

According to one aspect of the present invention, the image captured by the image sensor has no distortion because the projection lens is located at the center of the display screen, so the image captured by the image sensor is easy to be further processed. According to another aspect of the present invention, the projection lens can cover all projection area (i.e., display area of the display screen) which is desired to be covered by the image sensor because the image displayed on the screen is projected by the same projection lens, so the touches on all positions of the display screen can be detected via the projection lens. In other words, the infrared signal generated from all positions of the display area can travel to the projection lens along the projection light path and finally arrive at the image sensor, whereby the touches on all positions of the display area can be sensed by the image sensor. According to still another aspect of the present invention, the multiplexing of the projection lens has no influence on the projected image and the infrared image generated by the image sensor. According to yet another aspect of the present invention, the multiple touch detection can be achieved via the projection lens without any changes of the existing optical engine and any external camera, whereby the space and the cost are saved.

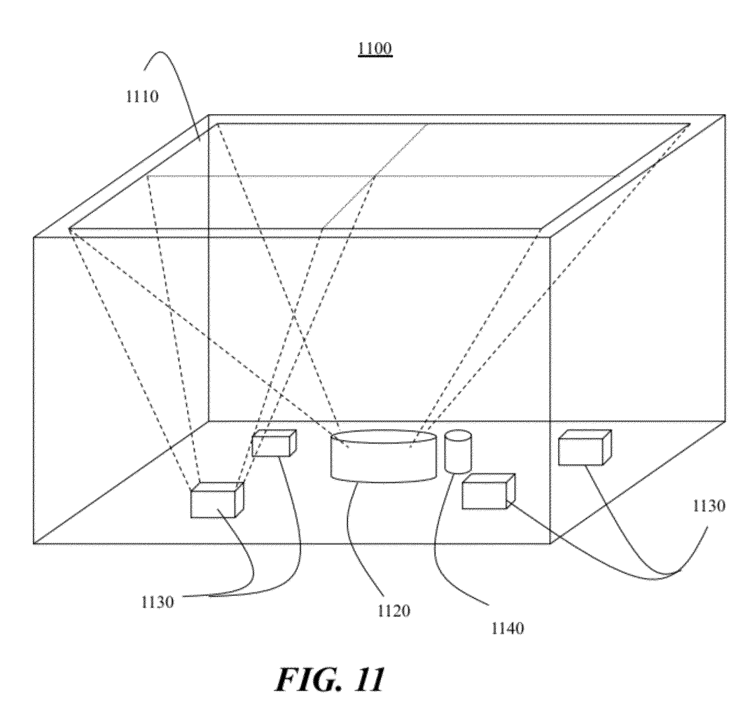

There is a plurality of ways to generate the infrared light when an object touches on the display screen. Several practical examples are described hereafter. In one embodiment, as shown in FIG. 11, an infrared emitter (e.g. IR LED) is disposed on one side of the display screen. The infrared light or near infrared light from the infrared emitter is emitted to the back of the display screen and cover the whole display screen. In a preferred embodiment, a plurality of IR LEDs is used to cover the whole display area of the display screen. Generally, the emitted infrared light is not reflected back. When an object touches on the display screen, the infrared light may be reflected back at the touch position. When two or more touches occur, the infrared light may be reflected back at each touch position, such as the infrared light 204 and 205 shown in FIG. 2. In this embodiment, the object touching the display screen may be a finger, an IR-based stylus, or other materials with reflectivity such as Silicon.

In another embodiment, a Frustrated Total Internal Reflection technique may be used to generate the infrared light. The display screen in this embodiment comprises an acrylic layer, an infrared emitter (e.g. a plurality of IR LEDs) is disposed at the edge of the acrylic layer. The infrared light emitted from the infrared emitter is totally reflected in the acrylic layer (referred as to Total Internal Reflection). When a user finger touches the acrylic layer, the total internal reflection may be broken, and the infrared light can be reflected at the touch position. Likewise, the infrared light may be reflected at each touch position if multiple touches occur in this embodiment.

In still another embodiment, the human body is used as an infrared light source. When a finger touches the display screen, the finger with body temperature will emit an infrared light that may be captured by the image sensor. In yet another embodiment, an IR stylus is used to generate an infrared light captured by the image sensor. The infrared light emitted by the IR stylus passes though the display screen (back projection application) or is reflected by the display screen (front projection application), and arrives at the projection lens, even if the IR stylus does not touch the display screen.

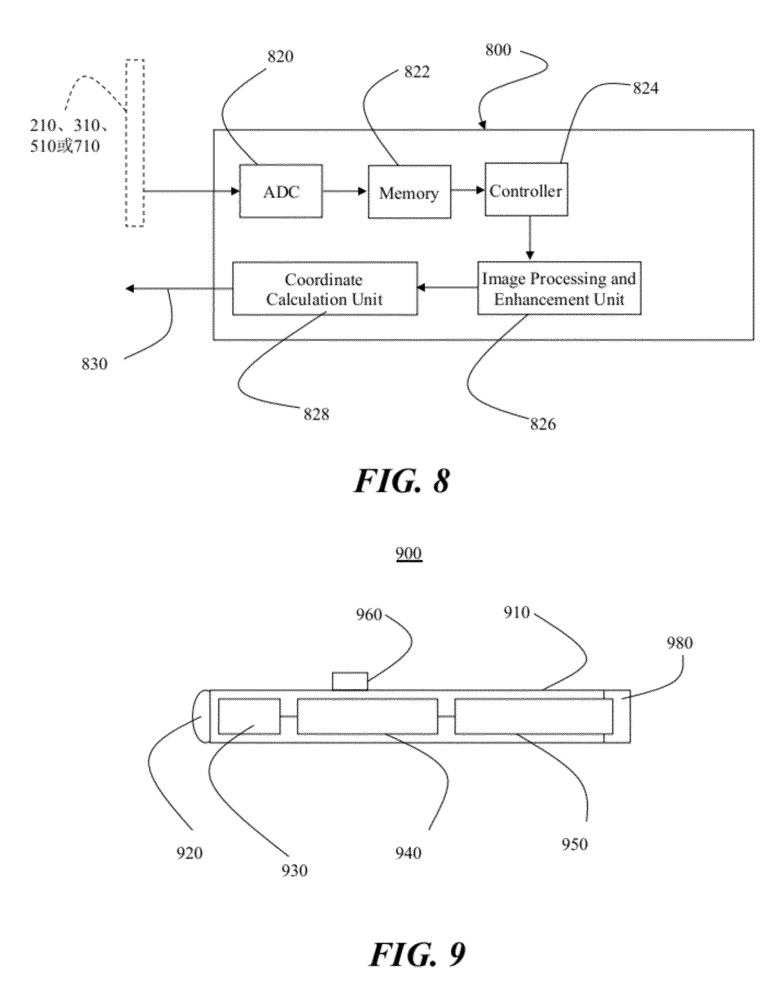

FIG. 8 shows a functional block diagram of an image processing module 800 that may be used to determine locations of one or more touches on a projection screen. The image processing module 800 may correspond to the image processing module 230 shown in FIG. 2, the image processing module 330 shown in FIG. 3, the image processing module 530 shown in FIG. 5, and the image processing module 730 shown in FIG. 7. The image captured by the image sensor 210, 310, 510 or 710 is provided to the image processing module 800. As shown in FIG. 8, the image processing module 800 comprises an analog-to-digital converter (ADC) 820, a memory 822, a controller 824, an image processing and enhancement unit 826 and a coordinate calculation unit 828. Depending on implementation, program code stored in the memory 822 causes the controller 824 to synchronize all other units to determine the coordinates of one or more touches in a captured image. In operation, the ADC 820 is configured to convert the received image to a digital image that is temporarily stored in the memory 822. The controller 824 retrieves the stored image data from the memory 822 and causes the image processing and enhancement unit 826 to process and enhance the image in accordance with pre-designed algorithms. The coordinate calculation unit 828 receives the processed and enhanced image data to calculate the corresponding coordinates of the IR inputs or touches. The results 830 are sent to external devices for subsequent operations, for example, to determine the movements of the touches.

FIG. 9 shows an exemplary IR stylus 900 in one embodiment of the present invention. The IR stylus 900 has a slander case 910 with an opening or a clear window 920 on one end. The slander case 910 contains a battery chamber 650 electrically connected through a power control circuit 940 and a switch 960 on the case to at least one IR LED 930 behind the clear window 920. The infrared light from the IR LED 930 is transmitted though the clear window 920. The IR LED 930 is switched on or off by the switch 960. The end opposite to the clear window 920 has a removal cap 980 for putting a battery into the battery chamber 950 or removing the battery from the battery chamber 950.

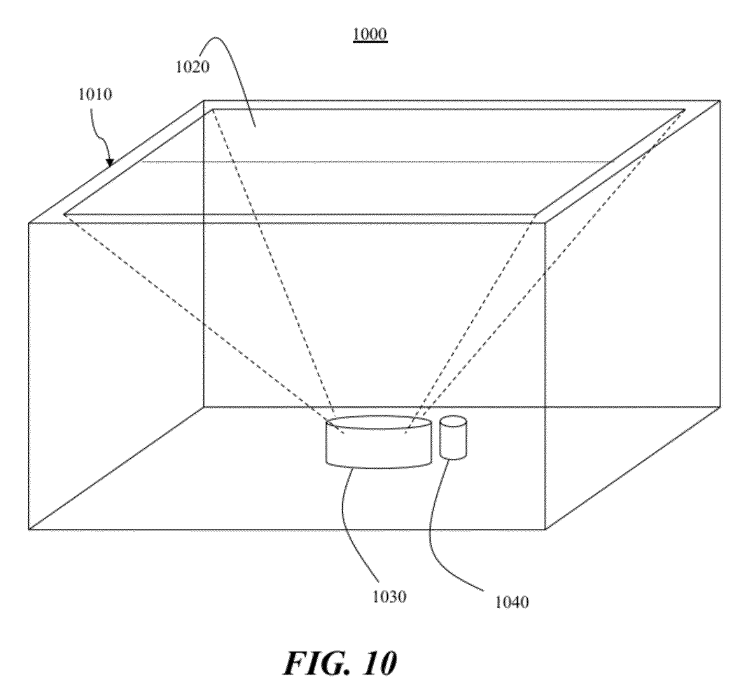

FIG. 10 shows a table computer with multiple touch detection 1000 according to one embodiment of the present invention. The table computer 1000 comprises a table 1010 having a cavity therein, a display screen 1020 used as a top surface of the table 1010 and a projection display system 1030 disposed in the cavity. The projection display system 1030 may include all components of a projection display system shown in FIG. 2, 3, 5 or 7 except for the display screen. The table computer 1000 can detect multiple touches at the same time even if external camera is not employed. In another embodiment, the table computer 1000 further comprises an infrared LED 1040 disposed in the cavity.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

What is claimed is:

1. A projection system comprising:
a screen;
an optical engine configured to produce an optical image based on a digital image;
a projection lens configured to project the optical image onto the screen, and allow an infrared light from the screen to pass through; and
an image sensor provided to sense the infrared light passing through the projection lens to generate a sensing image.

2. The projection system as claimed in claim 1, further comprising an image processing module provided to receive the sensing image from the sensor, and determine coordinates of a touch on the screen causing the infrared light according to the sensing image.

3. The projection system as recited in claim 2, wherein the optical engine comprises a guidance mirror assembly, three LCD panels and an optical prism assembly, and wherein
the guidance mirror assembly is configured to separate a white light from a light source into three primary color lights including a red light, a green, and a blue light, and direct the three primary color lights to corresponding LCD panels,
each LCD panel is configured to generate one primary color image by modulating the incident primary color light thereof based on pixels of the digital image, and
the optical prism assembly is responsible for combining the three primary color images to a full color image.

4. The projection system as recited in claim 3, wherein the infrared light passing through the projection lens enters into the optical prism assembly and is directed to the image sensor by the optical prism assembly.

5. The projection system as recited in claim 1, wherein the optical engine comprises a first LCOS micro-device, a second LCOS micro-device, a third LCOS micro-device, a first polarizing beam splitter, a second polarizing beam splitter, and a third polarizing beam splitter, and wherein
the first polarizing beam splitter provides one primary color light for the first LCOS micro-device, the second polarizing beam splitter provides one primary color light for the second LCOS micro-device and the third LCOS micro-device respectively,
each LCOS micro-device is configured to generate one primary color image by modulating the incident primary color light thereof based on pixels of the digital image, and
the third polarizing beam splitter is responsible for combining the three primary color images to a full color image.

6. The projection system as recited in claim 5, wherein the first LCOS micro-device is disposed at one side of the first polarizing beam splitter, the second LCOS micro-device is disposed at one side of the second polarizing beam splitter, the third LCOS micro-device is disposed at another side of the second polarizing beam splitter, and the image sensor is disposed at another side of the first polarizing beam splitter, and wherein
the infrared light passing through the projection lens is directed to the image sensor via the third polarizing beam splitter and the first polarizing beam splitter.

7. The projection system as recited in claim 1, wherein the optical engine comprises a polarizing beam splitter and a LCOS micro-device disposed at one side of the polarizing beam splitter, and wherein
the polarizing beam splitter reflects an incident light thereof to the LCOS micro-device, and
the LCOS micro-device is configured to generate an optical image by modulating an incident light thereof based on pixels of the digital image.

8. The projection system as recited in claim 7, wherein the image sensor is disposed at another side of the polarizing beam splitter, and wherein the infrared light passing through the projection lens is reflected to the image sensor via the polarizing beam splitter.

9. A table computer, comprising:
a table structure;
a display screen being a surface of the table structure;
an optical assembly disposed in the table structure;
an image sensor provided to sense at least a touch on the display screen to generate a sensing image; and
an image processing module provided to determine coordinates of the touch on the display screen according to the sensing image generated by the image sensor.

10. The table computer as recited in claim 9, wherein the optical assembly comprises an optical engine configured to produce an optical image based on a digital image and a projection lens configured to project the optical image onto the display screen and allow an infrared light from the display screen to pass through.

11. The table computer as recited in claim 10, wherein the optical engine comprises a guidance mirror assembly, three LCD panels and an optical prism assembly, and wherein
the guidance mirror assembly is configured to separate a white light from a light source into three primary color lights including a red light, a green, and a blue light, and direct the three primary color lights to corresponding LCD panels,
each LCD panel is configured to generate one primary color image by modulating the incident primary color light thereof based on pixels of the digital image, and
the optical prism assembly is responsible for combining the three primary color images to a full color image.

12. The table computer as recited in claim 10, wherein the optical engine comprises a first LCOS micro-device, a second LCOS micro-device, a third LCOS micro-device, a first polarizing beam splitter, a second polarizing beam splitter, and a third polarizing beam splitter, and wherein
the first polarizing beam splitter provides one primary color light for the first LCOS micro-device, the second polarizing beam splitter provides one primary color light for the second LCOS micro-device and the third LCOS micro-device respectively,
each LCOS micro-device is configured to generate one primary color image by modulating the incident primary color light thereof based on pixels of the digital image, and
the third polarizing beam splitter is responsible for combining the three primary color images to a full color image.

13. The table computer as recited in claim 10, wherein the optical engine comprises a polarizing beam splitter and a LCOS micro-device disposed at one side of the polarizing beam splitter, and wherein
the polarizing beam splitter reflects an incident light thereof to the LCOS micro-device,
the LCOS micro-device is configured to generate an optical image by modulating an incident light thereof based on pixels of the digital image,
the image sensor is disposed at another side of the polarizing beam splitter, and
the infrared light passing through the projection lens is reflected to the image sensor via the polarizing beam splitter.

14. A projection system, comprising:
a screen;
an optical assembly configured to project an optical image onto the screen;
an image sensor provided to sense at least a touch on the screen.

15. The projection system as recited in claim 14, further comprising an image processing module provided to receive a sensing image generated by the image sensor and determine coordinates of the touch on the display screen according to the sensing image.

16. The projection system as recited in claim 14, wherein the optical assembly comprises an optical engine configured to produce the optical image based on a digital image and a projection lens configured to project the optical image onto the screen and allow an infrared light from the screen to pass through.

17. The projection system as recited in claim 16, wherein the projection lens eliminates a visible light and an ultraviolet light from the screen.

18. The projection system as recited in claim 16, wherein the optical engine comprises a guidance mirror assembly, three LCD panels and an optical prism assembly, and wherein
the guidance mirror assembly is configured to separate a white light from a light source into three primary color lights including a red light, a green, and a blue light, and direct the three primary color lights to corresponding LCD panels,
each LCD panel is configured to generate one primary color image by modulating the incident primary color light thereof based on pixels of the digital image, and
the optical prism assembly is responsible for combining the three primary color images to a full color image.

19. The projection system as recited in claim 16, wherein the optical engine comprises a first LCOS micro-device, a second LCOS micro-device, a third LCOS micro-device, a first polarizing beam splitter, a second polarizing beam splitter, and a third polarizing beam splitter, and wherein
the first polarizing beam splitter provides one primary color light for the first LCOS micro-device, the second polarizing beam splitter provides one primary color light for the second LCOS micro-device and the third LCOS micro-device respectively,
each LCOS micro-device is configured to generate one primary color image by modulating the incident primary color light thereof based on pixels of the digital image, and
the third polarizing beam splitter is responsible for combining the three primary color images to a full color image.

20. The projection system as recited in claim 16, wherein the optical engine comprises a polarizing beam splitter and a LCOS micro-device disposed at one side of the polarizing beam splitter, and wherein
the polarizing beam splitter reflects an incident light thereof to the LCOS micro-device,
the LCOS micro-device is configured to generate an optical image by modulating an incident light thereof based on pixels of the digital image,
the image sensor is disposed at another side of the polarizing beam splitter, and
the infrared light passing through the projection lens is reflected to the image sensor via the polarizing beam splitter.
